(19) United States
(12) Patent Application Publication
(10) Pub. No.: US 2013/0262995 A1
(43) Pub. Date: Oct. 3, 2013

(54) Systems and Methods for Menu and Shopping List Creation

(71) Applicant: David Howell, Singapore (SG)

(72) Inventor: David Howell, Singapore (SG)

(21) Appl. No.: 13/438,360

(22) Filed: Apr. 3, 2012

(51) Int. Cl. G06F 17/00

(52) U.S. Cl. 715/273

(57) ABSTRACT

A computer-readable medium storing computer-executable instructions for: (1) tracking an inventory of ingredients available to a user; (2) generating at least one menu based at least in part on user defined criteria; and (3) creating shopping lists containing at least the ingredients required to prepare recipes included in the at least one menu. In various embodiments, the computer-readable medium stores instructions for generating menus that do not include recipes that contain ingredients from a list of ingredients to exclude. In particular embodiments, the computer-readable medium stores instructions for creating shopping lists that do not include ingredients in the inventory of ingredients available to the user.

### BACKGROUND

Menu planning is often difficult and time consuming. Meals may require forethought and planning to ensure that undesirable ingredients are not included in meals and to ensure that required ingredients are acquired before attempting to prepare a particular meal. Occasionally, a person may purchase an ingredient that they already own, resulting in excess or waste. Currently, there are recipe databases available that users can use to plan meals. There is a need for improved systems that would further reduce the effort and time required for meal planning.

### SUMMARY OF VARIOUS EMBODIMENTS

A computer-readable medium, according to various embodiments, stores computer-executable instructions for: (1) receiving, from a user, a listing of one or more ingredients to exclude from a particular set of menus; (2) after receiving the listing of one or more ingredients, using a computer to analyze a plurality of recipes to determine which of the recipes includes any one of the one or more excluded ingredients; (3) generating a plurality of menus for the user that only include recipes that were determined not to include any of the one or more excluded ingredients; and (4) communicating the plurality of menus to the user (e.g., by displaying the plurality of menus on a computer display screen, generating and playing a digital audio file that includes the plurality of menus, or through any other suitable communications mechanism).

A computer-readable medium, according to further embodiments, stores computer-executable instructions for: (1) receiving, from a user, a listing of one or more ingredients that are available to the user; (2) after receiving the listing of one or more ingredients, analyzing a plurality of recipes to determine which of the recipes only includes ingredients from the listing of available ingredients; (3) generating at least one menu for the user that only includes recipes that were determined to include the one or more available ingredients; and (4) communicating the at least one menu to the user (e.g., by displaying the plurality of menus on a computer display screen, generating and playing a digital audio file that includes the plurality of menus, or through any other suitable communications mechanism).

A computer-readable medium for generating a shopping list (e.g., a digital shopping list) for one or more recipes, according to various embodiments, stores computer-executable instructions for: (1) receiving, from a user, a listing of one or more ingredients that are available to the user; (2) determining, based on the listing of available ingredients, whether at least one of the one or more ingredients needed to prepare the one or more recipes is included on the listing of available ingredients; and (3) excluding the particular ingredients from the shopping list.

### BRIEF DESCRIPTION OF THE DRAWINGS

Having thus described various embodiments in general terms, reference will now be made to the accompanying drawings, which are not necessarily drawn to scale, and wherein:

FIG. 1 is a block diagram of a system according to one embodiment.

FIG. 2 is a block diagram of a Menu Maker Server of FIG. 1.

FIG. 3 is a flowchart showing steps executed by an Inventory Module according to a particular embodiment.

FIG. 4 is a flowchart showing steps executed by a Menu Maker Module according to a particular embodiment.

FIG. 4a is a flowchart showing steps executed by a Menu Maker Module according to another embodiment.

FIG. 4b is a flowchart showing steps executed by a Menu Maker Module according to yet another embodiment.

FIG. 5 is a flowchart showing steps executed by a Shopping List Maker Module according to a particular embodiment.

FIGS. 6-10 are screen displays of a system according to a particular embodiment.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Overview

Computer systems and/or methods according to particular embodiments are adapted for providing users with food menus for various numbers of meals. For example, a user may desire to create menus for three meals per day for an entire week; the system, in this case, would generate menus of meals for three meals per day for a week. In various embodiments, the system is adapted to receive a list of ingredients from a user that the user wishes to exclude from the various menus. If, for example, the user is allergic to peanuts, the user may include peanuts on the list of ingredients to exclude. In some embodiments, the system may be adapted to compile a shopping list of ingredients required to prepare the meals from the various generated menus. In particular embodiments, the system may generate a shopping list that takes into account ingredients that are already available to a user by excluding such ingredients from the shopping list. The system may also be adapted to forward shopping list information to suppliers, which may then deliver or compile the items on the shopping list for the user.

Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

Exemplary System Architecture

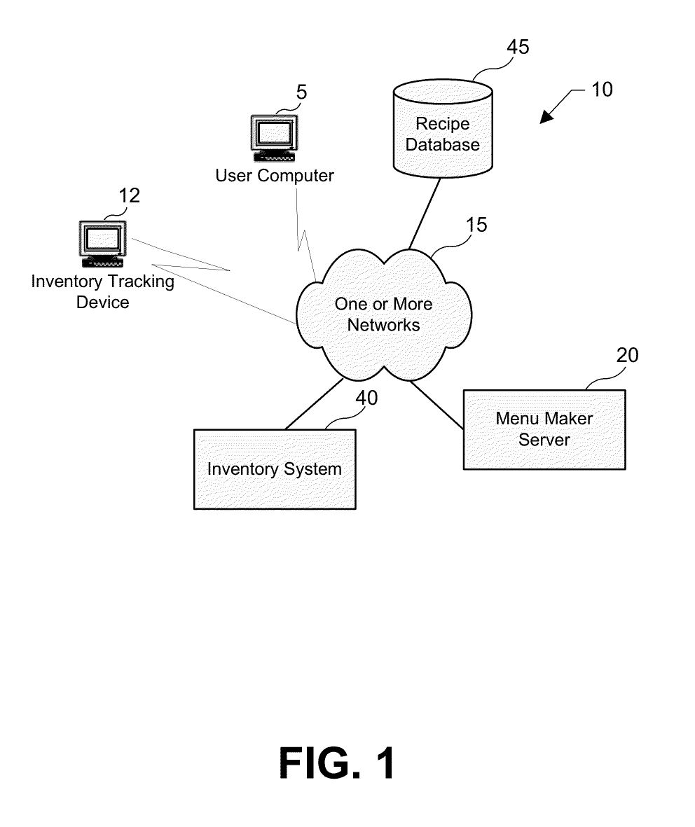

FIG. 1 shows a block diagram of a Menu Maker System 10 according to a particular embodiment. As may be understood from this figure, the Menu Maker System 10 includes at least one User Computer 5 (e.g., a tablet computer, smart phone, laptop, or other suitable User Computer), at least one Inventory Tracking Device 12 (e.g., an RFID tag reader, bar code scanner, or other suitable inventory tracking device), one or more computer networks 15, a Menu Maker Server 20, an Inventory System 40, and a Recipe Database 45. The one or more computer networks 15 facilitate communication between the User Computer 5, Inventory Tracking Device 12, Menu Maker Server 20, Inventory System 40, and Recipe Database 45. These one or more computer networks 15 may include any of a variety of types of computer networks such as the Internet, a private intranet, a public switch telephone network (PSTN), or any other type of network known in the art. In certain variations of the embodiment shown in FIG. 1, both the communication link between the User Computer 5, Inventory Tracking Device 12, Menu Maker Server 20, Inventory system 40, and Recipe Database 45 are implemented via the Internet using Internet protocol (IP). The communication link between the Menu Maker Server 20 and the Recipe Database 45 may be, for example, implemented via a Local Area Network (LAN).

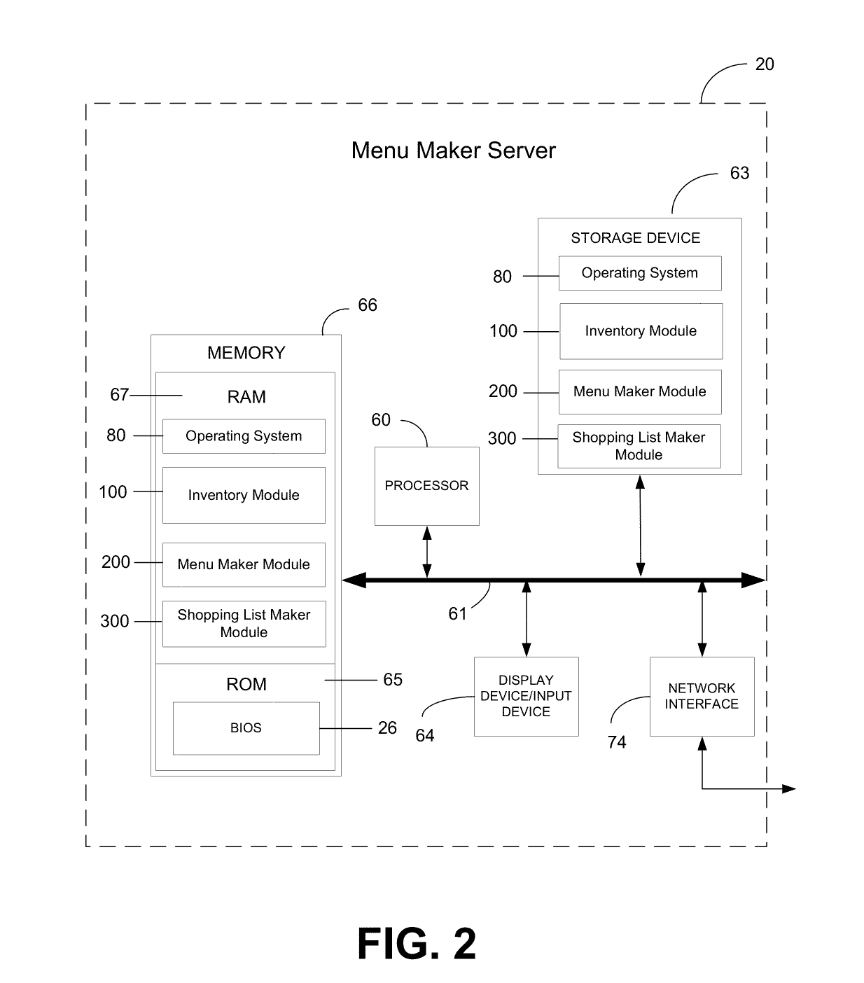

FIG. 2 shows a block diagram of an exemplary embodiment of the Menu Maker Server 20 of FIG. 1. The Menu Maker Server 20 includes a processor 60 that communicates with other elements within the Menu Maker Server 20 via a system interface or bus 61. Also included in the Menu Maker Server 20 is a display device/input device 64 for receiving and displaying data. This display device/input device 64 may be, for example, a keyboard, voice recognition, or pointing device that is used in combination with a monitor. The Menu Maker Server 20 further includes memory 66, which preferably includes both read only memory (ROM) 65 and random access memory (RAM) 67. The server's ROM 65 is used to store a basic input/output system 26 (BIOS) that contains the basic routines that help to transfer information between elements within the Menu Maker Server 20.

In addition, the Menu Maker Server 20 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for the Menu Maker Server 20. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80, an Inventory Module 100, a Menu Maker Module 200, and a Shopping List Maker Module 300. The Inventory Module 100, Menu Maker Module 200, and Shopping List Maker Module 300 control certain aspects of the operation of the Menu Maker Server 20, as is described in more detail below, with the assistance of the processor 60 and an operating system 80.

Also located within the Menu Maker Server 20 is a network interface 74 for interfacing and communicating with other elements of a computer network. It will be appreciated by one of ordinary skill in the art that one or more of the Menu Maker Server 20 components may be located geographically remotely from other Menu Maker Server 20 components. Furthermore, one or more of the components may be combined, and additional components performing functions described herein may be included in the Menu Maker Server 20.

### Exemplary System Modules

As noted above, various aspects of the system's functionality may be executed by certain system modules, including the system's Inventory Module 100, Menu Maker Module 200, and Shopping List Maker Module 300. These modules are discussed in greater detail below.

Inventory Module

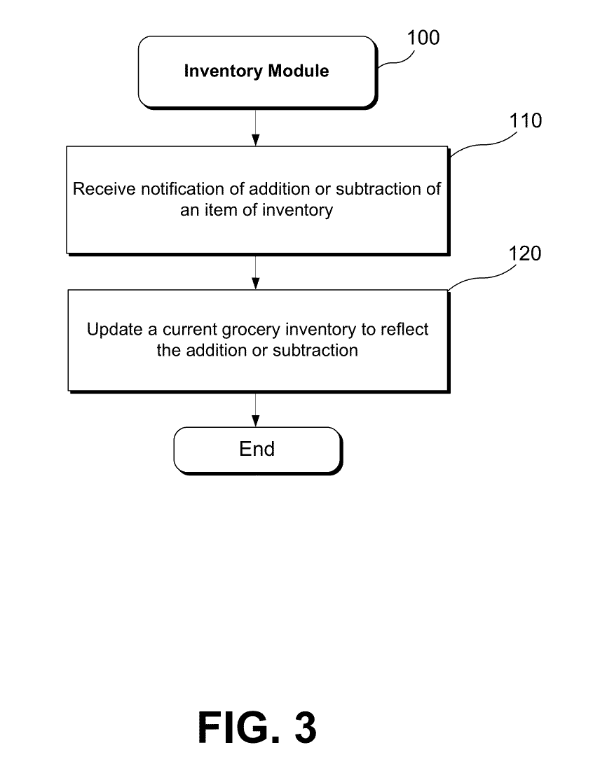

FIG. 3 is a flow chart of an exemplary Inventory Module 100. As may be understood from FIG. 3, certain embodiments of the Inventory Module 100 are configured to maintain an up to date inventory of ingredients that a user has available (e.g., in their kitchen). For example, the system may keep an inventory of amounts, weights, volumes, or other useful information regarding a user's available ingredients.

When executing an Inventory Module 100, the system begins, at Step 110, by receiving a notification of the addition or subtraction of an item of inventory (e.g., of a food ingredient). The system then updates the current inventory, at Step 120, to reflect the addition or subtraction of the particular items.

The system may receive the notification, for example, via a bar code reader that a user uses: (1) to scan grocery items before they are placed into the user's inventory of available ingredients (e.g., into the user's pantry or refrigerator); and (2) to scan items as they are permanently removed from the user's inventory (e.g., the item is thrown away, eaten, or used to prepare a meal). In various embodiments, the system may include a scale that allows a user to weigh an item after using it and before replacing the item into the user's pantry or refrigerator. Using this technique, the system may track the addition or subtraction of inventory through the changing weight of items of inventory.

In particular embodiments, the system 10 may track the addition or subtraction of items of inventory through the use of RFID tags placed on each item of inventory. In such embodiments, the system may include an RFID reader in or near the user's refrigerator or pantry that may be used to keep track of the user's various inventory items. In some embodiments, the system may receive notification of the addition or subtraction of an item of inventory through manual entry by a user. The user may, for example, manually indicate the addition or subtraction of an item using a touchscreen device or other suitable device.

In particular embodiments, the system may at least substantially track the addition or subtraction of inventory based at least in part on the recipes that a user of the system prepares. In particular, the system may be adapted to at least substantially automatically update an inventory database to delete items used in the preparation of a particular recipe once the recipe is prepared.

Menu Maker Module

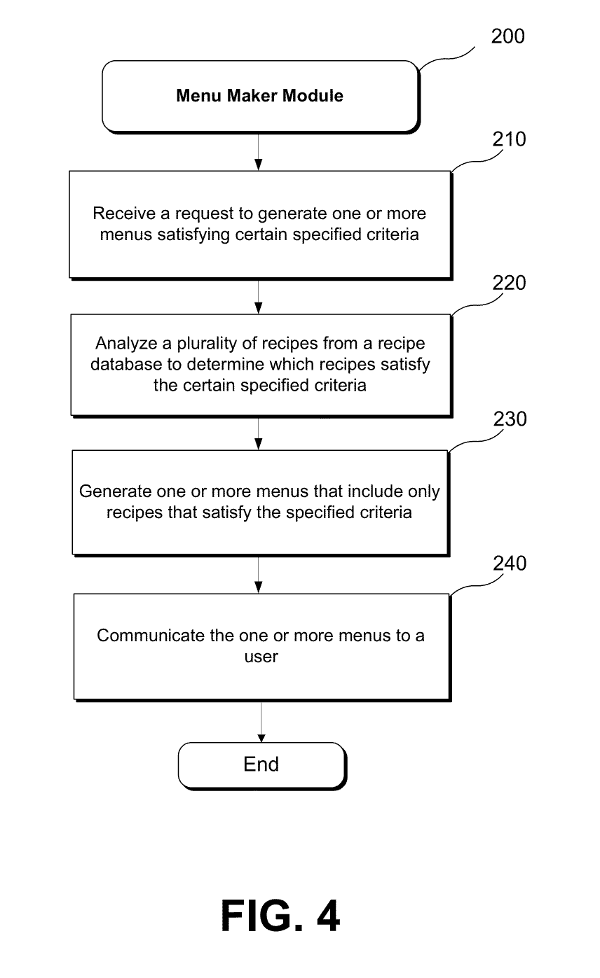

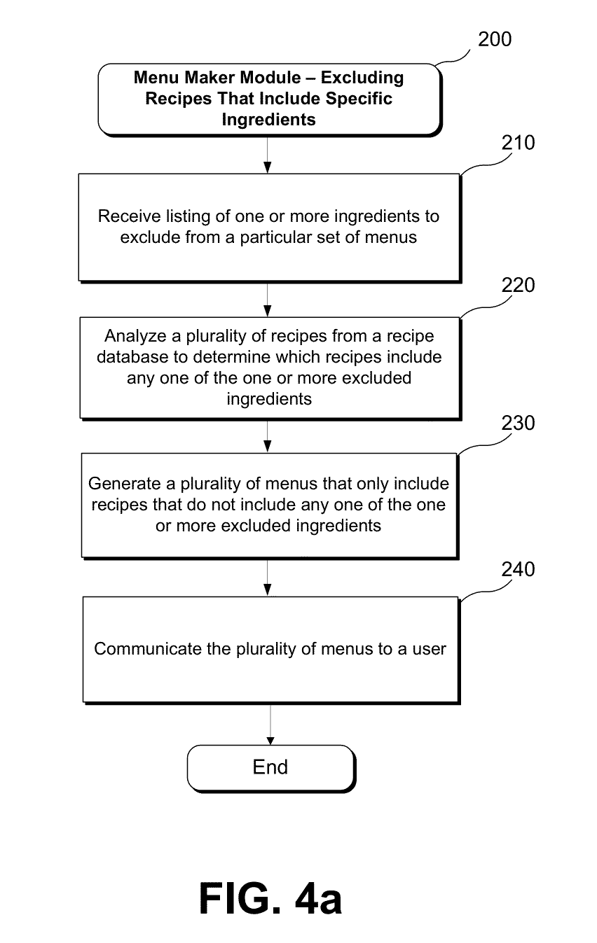

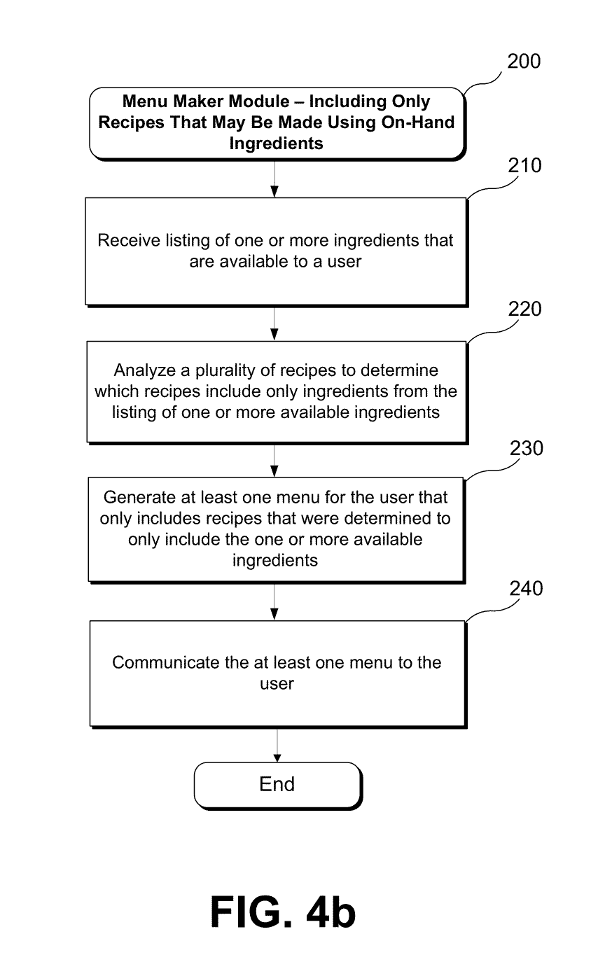

FIG. 4 is a flow chart of an exemplary Menu Maker Module 200. As may be understood from this figure, certain embodiments of the Menu Maker Module 200 are configured to generate a plurality of menus that meet certain specified criteria. The certain specified criteria may include, for example, ingredients that recipes in a menu cannot contain, limitations on the inclusion of particular ingredients (e.g., fish no more than twice per week), direction to include a certain ingredient with at least a particular frequency (e.g., chicken at least three days a week), instructions that recipes include only ingredients that a user has currently available, or any other suitable criteria for the creation of menus. For example, the system may be used to generate a week's worth of meals including breakfast, lunch and dinner that do not include a particular ingredient such as potatoes.

Beginning at Step 210, the system receives a request to generate one or more menus satisfying certain specified criteria. For example, the system may receive a list of ingredients to exclude from the particular set of menus from a user, and the list may include, for example, particular ingredients that the user does not enjoy, has an allergy to, or chooses not to eat for religious or spiritual reasons. As a particular example, the user may provide a list of ingredients to exclude that includes chicken. The particular set of menus may include any number of menus including, for example, a menu for a single meal or menus for three meals per day for an entire year.

The system then, at Step 220, analyzes a plurality of recipes from a recipe database to determine which recipes satisfy the specified criteria. At Step 230, the system then, based at least in part on the analysis conducted at Step 220, generates a plurality of menus that only include recipes that satisfy the specified criteria. For example, if the user had included chicken on the list of ingredients to exclude, the plurality of menus would not include any chicken dishes.

At Step 240, the system then communicates the one or more menus to the user. The one or more menus may include, for example, the particular set of menus that the user indicated at Step 210.

FIGS. 4a and 4b are, respectively, flow charts of: (A) a Menu Maker Module that excludes recipes that include specific ingredients; and (B) a Menu Maker Module that includes only recipes that may be made using ingredients that the user has on-hand (e.g., in their personal cooking inventory).

Shopping List Maker Module

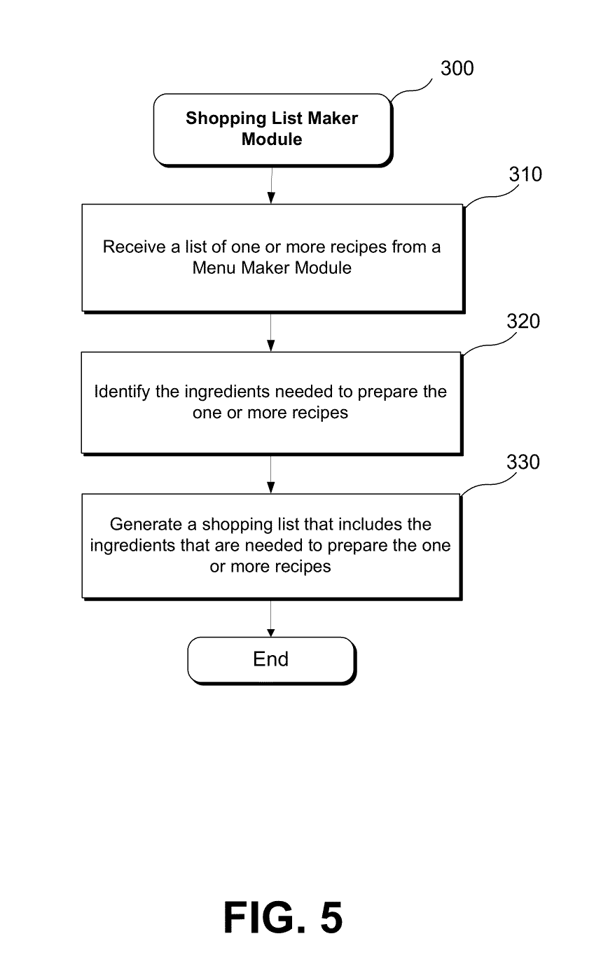

FIG. 5 is a flow chart of an exemplary Shopping List Maker Module 300. As may be understood from FIG. 5, certain embodiments of the Shopping List Maker Module 300 are configured to allow a system to generate a shopping list that includes ingredients that are needed to prepare one or more recipes (e.g., recipes that are included in menus generated by the Menu Maker Module 200). For example, if a user were preparing chicken quesadillas, the Shopping List Maker Module 300 would generate a shopping list that includes all of the ingredients required to make chicken quesadillas (e.g., chicken, cheese, tortillas, etc.)

Beginning at Step 310, the system receives a listing of one or more recipes from a Menu Maker Module. The system then, at Step 320, identifies the ingredients needed to prepare the one or more recipes. The ingredients may be identified, for example, from the recipes themselves. The system then generates, at Step 330, a shopping list that includes the ingredients needed to prepare the one or more recipes. In various embodiments, the generated shopping list may be organized, for example, alphabetically, by category of ingredient (e.g., meat, dairy, vegetables), or in any other suitable shopping list format. In particular embodiments, the shopping list may be organized based on an aisle of the grocery store in which the particular ingredients are located (e.g., “Aisle 1: bread, bagels; Aisle 2: eggs, milk, cheese; etc.”).

In particular embodiments, the Shopping List Maker Module 300 may be configured to utilize an Inventory Module 100 as part of an On-Hand Filter to consider which ingredients are available to a user when creating a shopping list. The module may then generate a shopping list that does not include ingredients that a user already has available (e.g., to prevent a user's purchase of unneeded ingredients).

In various embodiments, the Shopping List Maker Module 300 may create a digital shopping list that a user may transmit to an on-line grocery store. In such embodiments, the on-line grocery store may deliver the items on the shopping list to the user, or make the items available for local pick up by the user.

### Exemplary User Interface

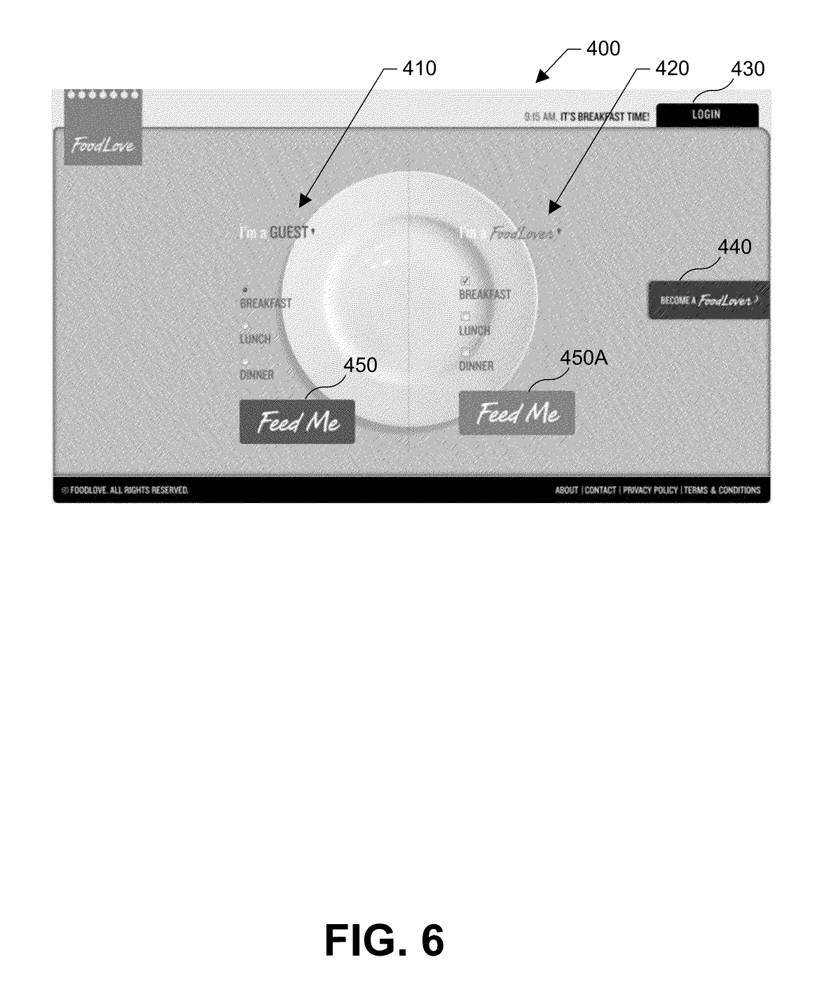

An exemplary user interface for a particular embodiment of a Menu Maker System 10 is shown in FIGS. 6-10. These figures represent interfaces displayed on tablet computers, desktop computers, laptops, handheld devices such as smart phones, and other similar devices. These interfaces may be used by users to access the system.

Login Screen

FIG. 6 shows a login screen 400 that includes an interface for both unregistered 410 and registered 420 users to access the system. A registered user may sign into the system at the login screen via a login button 430, for example, by using their user account and password. At the login screen 400, users also have the option of becoming a registered user by pressing a Become a Foodlover Button 440 or accessing the system as an unregistered user or guest. Once a user has elected whether to access the system as a guest or to register, the user may select a meal (e.g., breakfast, lunch, or dinner) for the system to generate a menu for. The user may then press the “Feed Me” 450, 450A button to initiate the system to generate a menu for the selected meal.

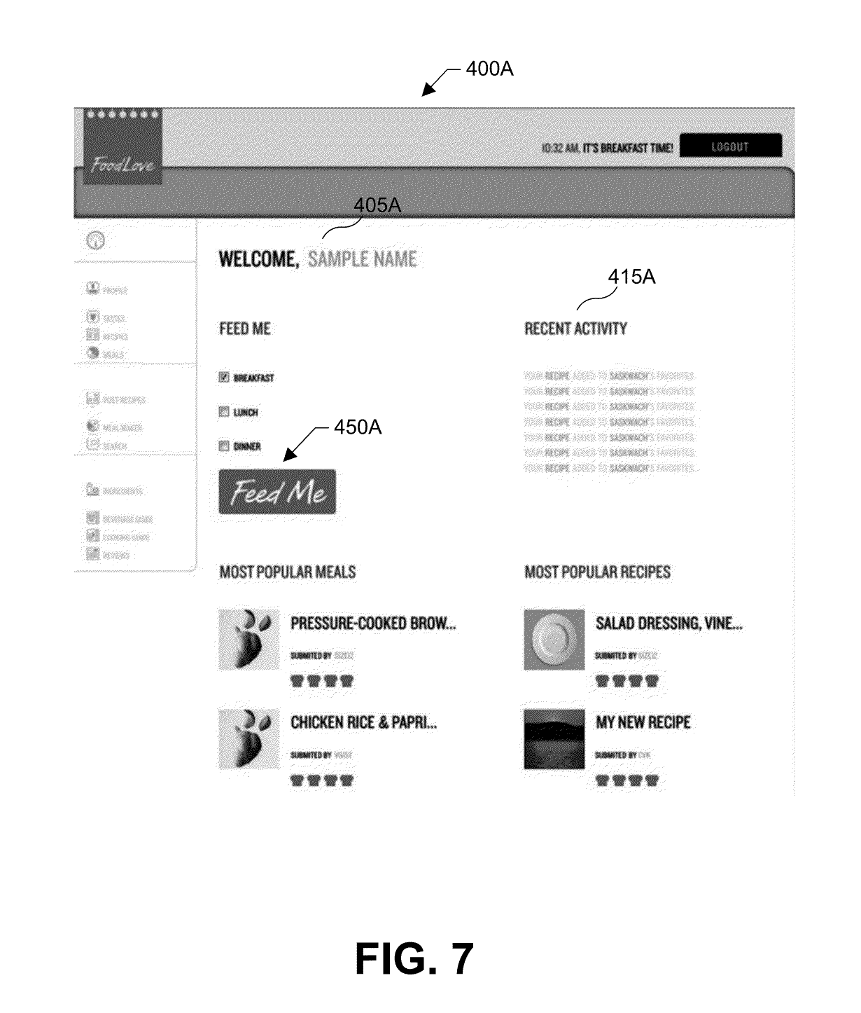

FIG. 7 shows a welcome screen in which a registered user has logged into their account. As may be understood from this figure, the system displays the user's login name 405A and includes information about the user's recent activity 415A. The registered user may then add user preferences such as ingredients to exclude from potential recipes that the menu maker may include in any menu.

Menu Review Screen

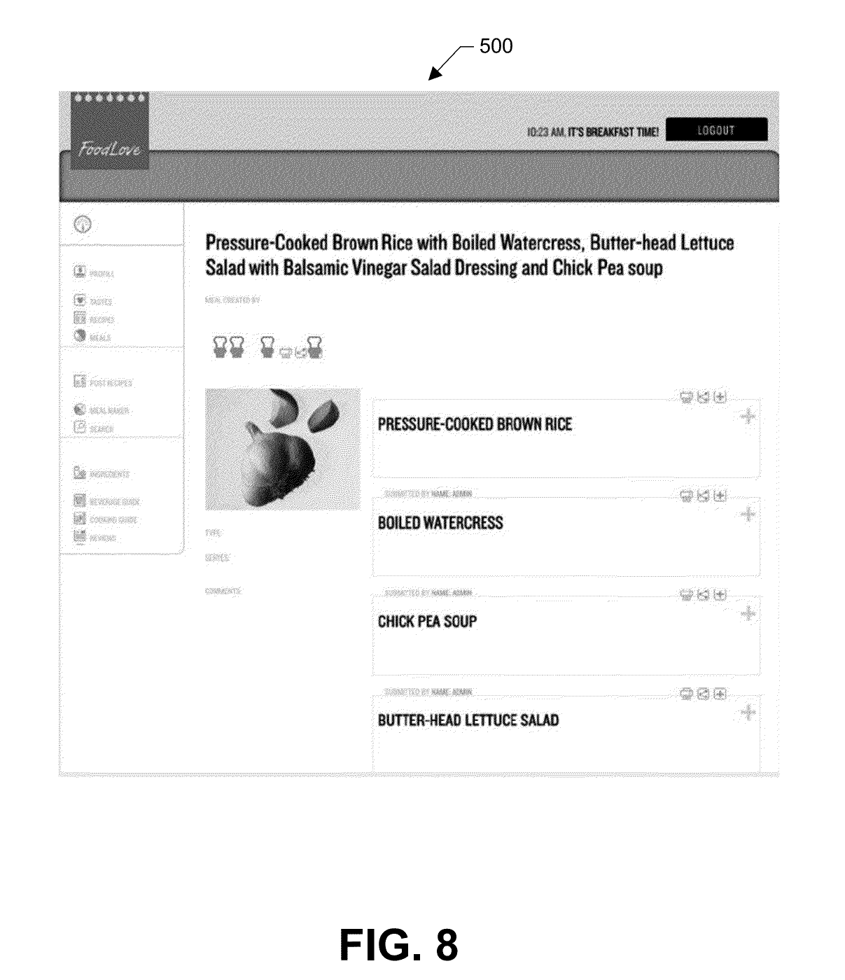

In various embodiments, the system includes a menu review screen 500 (See FIG. 8), which the user may use to have the system determine a single meal menu or multiple meal menus. When a user selects a single meal, for example lunch, the system will display the details of the particular meal including particular foods that are included in the meal as well as their ingredients. FIG. 8 shows a screen display that includes the details of a menu for a particular meal. A lunch may, for example, include oven roasted salmon; feta, sundried tomato, and fresh basil salad; and sautéed fennel and leek. A user may then choose to accept the meal and move on to a shopping list creation screen, or the user may elect to modify the meal at a menu modification screen.

When a user selects multiple meals at the menu review screen, the system will display all the meals for the period that the user selected. For example, if a user selected multiple meal menus for a week-long period, the system will display seven days' worth of meals including breakfast, lunch, and dinner. The user may then accept the meals and move on to the shopping list creation screen described below, or choose to modify the meals at the menu modification screen.

Menu Modification Screen

In particular embodiments, the system may include a menu modification screen 600 that displays system generated menus. In the case of registered users, the system may apply a user preferences filter to only display menus containing recipes that do not include ingredients from a list of excluded ingredients.

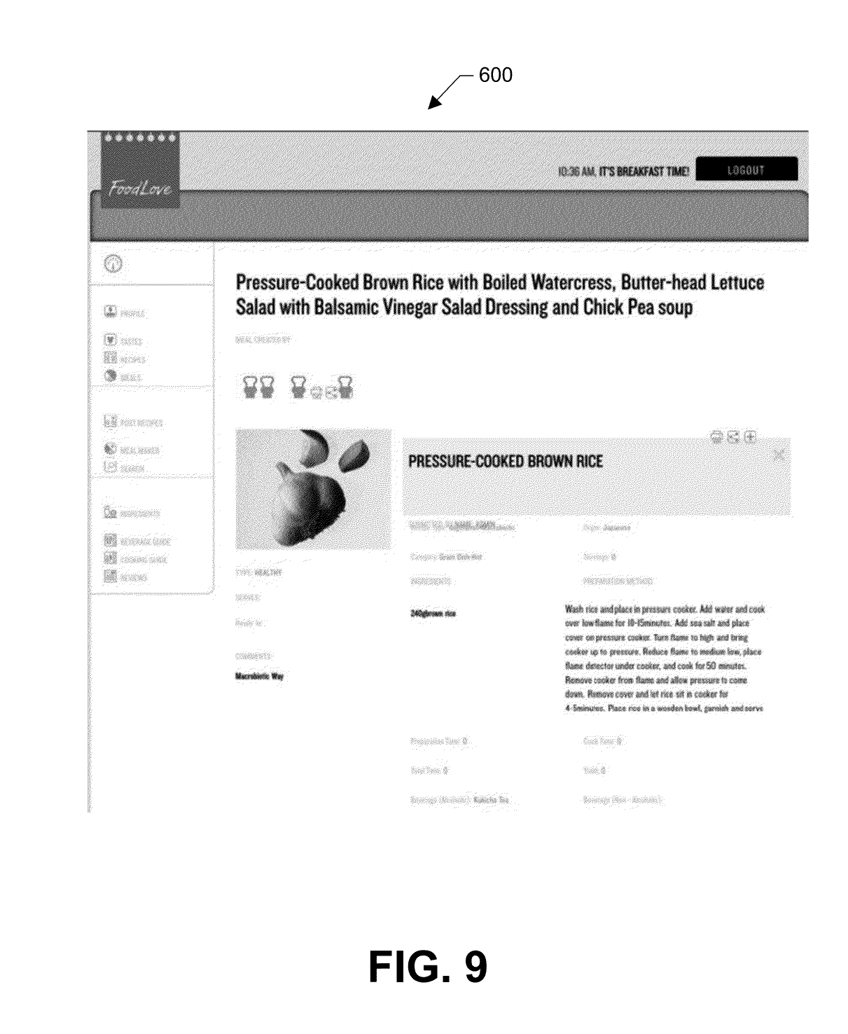

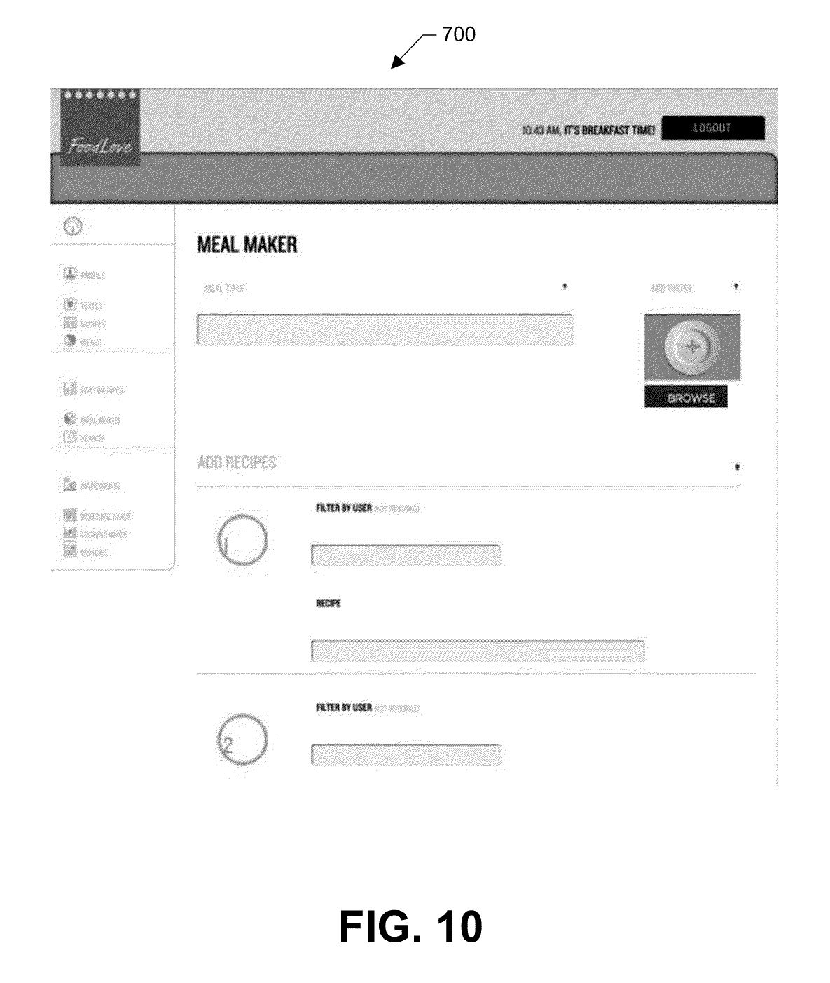

On the menu modification screen, the user may review the menus that the system displays to decide if the user is happy with the system generated menus. FIG. 9 shows a screen capture of an exemplary menu modification screen 600 where the user may view details of specific parts of a generated menu. If the user likes the menus, the user can approve the menu selection and select a button that takes the user to a shopping list creation screen. If the user does not like one of the menu items, the user can remove that menu item from the menu by selecting an appropriate button. The user may then direct the system to select a replacement dish from available categories such as pasta and grains, two legs, four legs, fruits, vegetables, or any other appropriate food category. For example, if the user would prefer not to have beef as part of a particular meal, the user can remove the beef dish from the menu, and direct the system to replace beef with another food from the ‘four legs’ category (e.g., lamb). In various embodiments, the system may be adapted to allow the user to manually select a replacement meal. FIG. 10 shows an exemplary meal maker interface 700 where a user may add recipes to a particular meal or menu. Once the user has modified the menu to their liking, the user may then select a button to continue on to the shopping list creation screen.

Shopping List Creation Screen

In particular embodiments, the system may include a shopping list creation screen that is adapted for creating a shopping list based on the system created menus. At the shopping list creation screen, the system compiles a list of required ingredients to make the recipes for the various menus. In various embodiments, the system may sort the shopping list by shopping categories (e.g., fruits and vegetables, grains, and meats).

For registered users, the system may apply an On Hand Filter at the shopping list creation screen that creates a shopping list that only includes ingredients that the user needs for the recipes but does not include ingredients that the user has available. The On Hand Filter compares the list of required ingredients against an inventory of available ingredients. As noted above, the inventory data may be compiled in any suitable manner including using a bar code scanner that scans goods when they arrive and again when they are disposed, using a refrigerator mass item scanner that periodically scans the items in a user's refrigerator, by comparing the current shopping list to previous shopping lists, or in any other suitable manner (e.g., using RFID technology).

At the shopping list creation screen, a user may also manually add items to the shopping list that were not included as being required for the system created menus. These additional items may include any other items in which the user may indulge such as snacks or other items such as toiletries. Once the user has added optionally additional items to the shopping list, the user may choose from different options: (1) the user may send the shopping list to a device (e.g., a mobile device such as a smart phone, or a tablet); (2) the user may print the shopping list; or (3) the user may send the shopping list to a shopping cart, which takes the user to an order completion interface.

Order Completion Interface

In particular embodiments, the system may include an order completion interface that allows a user to complete their menu transaction, receive their completed menu and shopping lists, and, if the user chooses, send the shopping list directly to a supplier that may order, deliver, or arrange for a user to pick up the items on the shopping list. The system may be adapted to facilitate this sending process by transmitting a digital version of the shopping list to the supplier via a suitable computer network. At the order completion interface, the user may select a Food Love Transaction Engine that will process a user's credit card or other payment information and place their order, which may then be sent to an appropriate supplier (e.g., via a suitable computer network or other communications network). In other embodiments of the order completion interface, users may select the Direct to Supplier Transaction Engine in which the user will deal directly with a supplier to complete the user's order. In embodiments comprising a Direct to Supplier Transaction Engine, the system may, for example, be adapted to deduct a commission from the third party supplier.

In particular embodiments, a supplier may be equipped to deliver all of the items on a particular shopping list to a user. In other embodiments, the supplier may collect all of the items on a particular shopping list and make them available for a user to pick up at a particular location. In various embodiments, suppliers may include, for example, online grocery stores, brick and mortar grocery stores, or any other appropriate food provider (e.g., a butcher shop).

### Other Suitable Uses

As should be understood in light of this disclosure, the system described above may be used in a variety of different contexts. For example, the system may be used by a catering company. In such an embodiment, the system may, for example, be equipped to create multiple menus for a particular meal. In a particular example, if a catering company is providing a meal for a wedding reception, the system may be adapted to create multiple menu choices such as a chicken dish, a fish dish, and a vegetarian dish. The system may be further adapted to create a shopping list of required ingredients based on feedback from wedding RSVP cards that include information about which meals particular wedding guests would prefer. The system may be adapted to take information regarding the number of guests at the wedding as well as their meal preferences to create a shopping list for the catering company that includes the proper amount of ingredients to prepare the correct number of each chosen meal for the wedding guests.

In other embodiments, the system may be adapted to create a menu for a certain period of time (e.g., a week) where the total cost of ingredients required to prepare the various meals on the menu does not exceed a specific cost. For example, a user may direct the system to create a menu for a week's worth of meals where the total cost of ingredients for all the meals does not exceed $100. The system may be adapted to receive ingredient pricing information from a database or from another source (e.g., an internet search) in order to determine appropriate menus. In particular embodiments, the system may be adapted to allow users to adjust a specific meal or menu item based on price. For example, a user may choose to replace filet mignon in a particular meal with strip steak. The user may, for example, direct the system to replace the item with a similar type of food (e.g., a meat) while also providing a maximum price they are willing to spend on that particular aspect of the meal. In this example, the user could direct the system to replace the filet mignon with a different meat dish that is priced at less than $5 per serving. The system, in this example, may then replace the filet mignon with an appropriately priced meat (e.g., chicken).

In particular embodiments, the system may be adapted to consider leftover food from previous meals when creating menus for a particular day. For example, if a dinner menu for a Monday had included lasagna, the system may include leftover lasagna on a menu for a later day such as lunch on Tuesday. The system may receive information concerning leftover food from particular meals, for example, through direct user input, through an imaging system in the user's refrigerator, or in any other suitable manner.

In various embodiments, the system may be adapted to receive user feedback in the form of ratings for particular menus or meals. In particular embodiments, user feedback may include user comments and/or numerical ratings (e.g., a rating between one and five). The system may be adapted to consider overall ratings of particular meals or menus when creating menus for particular users. For example, the system may be adapted to be more likely to select a highly rated menu item (e.g., a menu item with an average rating of four out of five) than a low rated menu item (e.g., a menu item with an average rating of two out of five). In particular embodiments, the system may be adapted to consider a user's previous menu ratings when selecting menus for that particular user. For example, if a user consistently assigns high ratings to meals with recipes that include spinach, the system may be adapted to be more likely to create menus for that user that include spinach in some capacity.

In various embodiments, the system may be adapted to remove particular recipes from the recipe database if the particular recipe receives consistently low user ratings (e.g., an average rating of two out of five or less). Alternatively, the system may be adapted to never create menus that include recipes that have been removed from the recipe database.

### CONCLUSION

Many modifications and other embodiments of the invention will come to mind to one skilled in the art to which this invention pertains having the benefit of the teachings presented in the foregoing descriptions and the associated drawings. While examples discussed above cover the use of the invention in the context of menu making, the invention may be used in any other suitable context. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

I claim:

1. A computer-readable medium storing computer-executable instructions for:
(A) receiving, from a user, a listing of one or more ingredients to exclude from a particular set of menus;
(B) after receiving said listing of one or more ingredients, using a computer to analyze a plurality of recipes to determine which of said recipes includes any one of said one or more excluded ingredients;
(C) generating a plurality of menus for said user that only include recipes that were determined, in said Step (B), not to include any of said one or more excluded ingredients; and
(D) communicating said plurality of menus to said user.

2. The computer-readable medium of claim 1, wherein said Step (B) comprises using said computer system to analyze an ingredient list associated with each of said plurality of recipes to determine which of said plurality of recipes includes said one or more excluded ingredients.

3. The computer-readable medium of claim 1, wherein said computer-readable medium further stores computer-executable instructions for generating a menu calendar in which each of a plurality of days has been associated with a particular one of said plurality of menus.

4. The computer-readable medium of claim 3, wherein said plurality of days comprises each day within a particular week.

5. The computer-readable medium of claim 1, wherein said computer-readable medium further stores computer-executable instructions for generating a menu calendar in which each of a plurality of days has been associated with a unique particular one of said plurality of menus.

6. The computer-readable medium of claim 5, wherein said plurality of days comprises each day within a particular week.

7. The computer-readable medium of claim 1, wherein each of said menus comprises a plurality of different recipes.

8. The computer-readable medium of claim 1, wherein said computer-readable medium further stores computer-executable instructions for generating a shopping list that includes one or more ingredients needed to prepare said plurality of meals.

9. The computer-readable medium of claim 8, wherein said computer-readable medium further stores computer-executable instructions for:
(D) receiving a listing of one or more ingredients that are available to said user;
(E) determining, based on said listing of available ingredients, whether at least one of said one or more ingredients needed to prepare said plurality of meals is included on said listing of available ingredients; and
(F) in response to determining that said at least a particular one of said one or more ingredients needed to prepare said plurality of meals is included on said listing of available ingredients, excluding said particular ingredient from said shopping list.

10. The computer-readable medium of claim 9, wherein said Step (D) comprises receiving a listing of one or more items that said user previously purchased from an on-line grocery provider.

11. The computer-readable medium of claim 9, wherein said Step (D) comprises receiving a listing of one or more items that are currently stored within said user's kitchen.

12. The computer-readable medium of claim 11, wherein said Step (D) comprises receiving a listing of one or more items that are currently stored within said user's refrigerator.

13. The computer-readable medium of claim 11, wherein said listing of one or more items that are currently stored within said user's refrigerator has been obtained at least in part by scanning a bar code associated with each of said one or more items as said item was placed in said refrigerator.

14. The computer-readable medium of claim 13, wherein said listing of one or more items that are currently stored within said user's refrigerator has been obtained at least in part by scanning a bar code associated with one or more items as they were discarded from said refrigerator.

15. The computer-readable medium of claim 12, wherein said listing of one or more items that are currently stored within said user's refrigerator has been obtained at least in part by reading an RFID tag associated with each of said one or more items as said item was placed in said refrigerator.

16. The computer-readable medium of claim 15, wherein said listing of one or more items that are currently stored within said user's refrigerator has been obtained at least in part by reading an RFID tag associated with one or more items as they were discarded from said refrigerator.

17. A computer-readable medium storing computer-executable instructions for:
(A) receiving, from a user, a listing of one or more ingredients that are available to said user;
(B) after receiving said listing of one or more ingredients, using a computer to analyze a plurality of recipes to determine which of said recipes only includes ingredients from said listing of available ingredients;
(C) generating at least one menu for said user that only includes recipes that were determined, in said Step (B), to only include said one or more available ingredients; and
(D) communicating said at least one menu to said user.

18. The computer-readable medium of claim 1, wherein said Step (A) comprises receiving a listing of one or more items that are currently stored within said user's kitchen.

19. The computer-readable medium of claim 2, wherein said Step (A) comprises receiving a listing of one or more items that are currently stored within said user's refrigerator.

20. A computer-readable medium storing computer-executable instructions for generating a shopping list for one or more recipes:
(A) receiving, from a user, a listing of one or more ingredients that are available to said user;
(B) determining, based on said listing of available ingredients, whether at least one of said one or more ingredients needed to prepare said one or more recipes is included on said listing of available ingredients; and
(C) in response to determining that said at least a particular one of said one or more ingredients needed to prepare said plurality of recipes is included on said listing of available ingredients, excluding said particular ingredient from said shopping list.

21. The computer-readable medium of claim 1, wherein said Step (A) comprises receiving a listing of one or more items that said user previously purchased from an on-line grocery provider.

22. The computer-readable medium of claim 1, wherein said Step (A) comprises receiving a listing of one or more items that are currently stored within said user's kitchen.
